(19) United States
(12) Patent Application Publication
(10) Pub. No.: US 2025/0140932 A1
(43) Pub. Date: May 1, 2025

(54) METHOD OF SINGULATING SOLID STATE BATTERIES BY STAMPING

(71) Applicant: Ensurge Micropower ASA, Oslo (NO)

(72) Inventors: Arvind KAMATH, Los Altos, CA (US); Hobart UTAMA, San Jose, CA (US); Shoba RAO, San Jose, CA (US)

(21) Appl. No.: 18/885,525

(22) Filed: Sep. 13, 2024

Related U.S. Application Data
(60) Provisional application No. 63/593,504, filed on Oct. 26, 2023.

(51) Int. Cl. H01M 10/0583; B26D 7/00; B26D 7/27; H01M 10/0585

(52) U.S. Cl. CPC H01M 10/0583; B26D 7/0006; B26D 7/27; H01M 10/0585

(57) ABSTRACT

A stamp or punch for dicing or singulating solid-state battery cells and method of separating solid-state battery cells on a sheet, roll or strip using the stamp or punch are disclosed. The method includes placing the sheet, the roll or a plurality of the strips and the stamp or punch face-to-face, and applying sufficient pressure to at least one of (a) the sheet, the roll or a carrier supporting the strips and (b) the stamp or punch to separate the sheet or roll into strips, or the plurality of strips into another plurality of strips, multi-cell units, or individual battery cells. the stamp or punch includes a base, blades in parallel with each other on the base, and guides or pegs on the base and completely outside all space between the outermost blades. Stamps for singulating the solid-state battery cells from the sheet, roll or multi-column strips is also disclosed.

### CROSS-REFERENCE TO RELATED APPLICATIONS

This application claims the benefit of U.S. Provisional Pat. Appl. No. 63/593,504, filed Oct. 26, 2023, pending, incorporated herein by reference in its entirety.

### FIELD OF THE INVENTION

The present invention generally relates to the field of solid-state and/or thin film batteries. More specifically, embodiments of the present invention pertain to a method of singulating solid-state batteries by stamping.

### DISCUSSION OF THE BACKGROUND

Solid-state lithium batteries are ionic-charge storage devices that are ideally suited for wearable, IoT, and other non-EV applications due to their small size, safety, and high cyclability. In order to achieve commercially acceptable microbattery capacities (for example, 0.1-100 mAh) in a limited areal footprint, unit cells are patterned and stacked in parallel to achieve the desired capacity (as opposed to forming the battery from one single large area device). The unit cells typically have, but are not limited to, area dimensions on the order of 1-15 mm per side.

Current solutions for singulating solid-state battery cells include laser dicing or mechanical sawing, both of which are unacceptably inefficient per unit area, as battery cell/die footprints become increasingly small. These solutions also tend to be slow, and can produce a sizable “edge burr” on the substrate. For example, laser cutting typically cuts only single paths or streets of die. As dies get smaller, the total street length for a given area of the substrate increases, reducing the throughput for typical microbattery dimensions. Also, when the substrate comprises a metal foil (such as a steel foil), such burrs can provide a shorting path in the stack of cells. Thus, a better solution is needed to provide a battery singulation solution at a lower capital cost, with a higher throughput (e.g., providing parallel singulation), and that results in a singulated die with good edge quality.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

The present invention relates to solid-state and thin film batteries, and more specifically to a method of singulating solid-state batteries by stamping. In some embodiments, a stamping tool such as a punch does the dicing/singulating in parallel (multiple die singulated in one punching operation), while maintaining the die-die spacing seen or used in laser dicing and mechanical sawing (typically, there is no reduction in die density/unit area when singulating by stamping, as opposed to laser dicing or mechanical sawing).

In one aspect, the present invention relates to a method of cutting or dicing solid-state battery cells, comprising placing (i) a sheet, a roll or a first plurality of battery cell strips and (ii) a first stamp or a first punch face-to-face, and applying sufficient pressure to at least one of (a) the sheet, the roll or the carrier and (b) the first stamp or the first punch to separate the sheet or the roll into a second plurality of battery cell strips, or the first battery cell strips into a third plurality of battery cell strips, a plurality of multi-cell units, or a plurality of individual battery cells. The sheet, the roll and the first battery cell strips comprise a substrate and a plurality of cells thereon in an array of rows and columns. The first battery cell strips are on a carrier. Each of the cells comprises a cathode on or over the substrate, a solid-state electrolyte on the cathode, and an anode current collector (ACC) on the electrolyte. The first stamp and the first punch comprise a first base, a plurality of first blades in parallel with each other on the first base, and a plurality of first guides or pegs on the base and completely outside all of the space between the outermost first blades. Herein, when a structure containing a substrate and multiple battery cells thereon and a stamp or punch are “face-to-face,” generally the ACCs in the cells (or the surface of the battery cells farthest away from the substrate) are facing the cutting edges of the blades.

In further embodiments, the stamp and the punch may further comprise a plurality of blade guides on the base. The blade guides may be configured to align the blades on the base with each other and/or with dicing channels on or in the sheet, the roll or the first battery cell strips. Generally, each of the blades has at least one blade guide at an end of the blade. In some embodiments, each blade has a blade guide at each of two opposite ends of the blade.

In some embodiments, the method comprises placing (i) the sheet or the roll and (ii) the first stamp or the first punch face-to-face, and applying sufficient pressure to at least one of (a) the sheet or the roll and (b) the first stamp or the first punch to separate the sheet or the roll into the second plurality of battery cell strips. The second battery cell strips may be the same as or different from (e.g., have a different number of columns from) the first battery cell strips.

In embodiments in which the sheet or the roll is separated into the second battery cell strips, each of the second plurality of battery cell strips comprises a plurality of columns of battery cells. For example, each of the second battery cell strips may include from two to eight columns of battery cells. Additionally, each of the second battery cell strips may include from two to 50 rows of battery cells.

In embodiments in which the sheet or the roll is separated into the second battery cell strips, the method may further comprise placing the second plurality of battery cell strips and a second stamp or a second punch face-to-face, and applying sufficient pressure to at least one of (a) the second plurality of battery cell strips and (b) the second stamp or the second punch to separate the second plurality of battery cell strips into a plurality of single-column strips. The second stamp and the second punch generally comprise a second base, a plurality of second blades in parallel with each other on the second base, and a plurality of second guides or pegs on the second base and completely outside all of the space between the outermost second blades. The second guides or pegs may be in locations on the second base identical to locations of the first guides or pegs on the first base, and the second blades may be oriented with respect to the second guides or pegs (or the columns of cells in the second battery cell strips) identically to an orientation of the first blades with respect to the first guides or pegs (or the columns of cells in the preceding sheet or roll). In such embodiments, the second blades may be in locations on the second base that are offset from locations of the first blades on the first base.

In embodiments in which the sheet or the roll is separated into the second battery cell strips, the method may further comprise placing the single-column strips and a third stamp or a third punch face-to-face, and applying sufficient pressure to at least one of (a) the single-column strips and (b) the third stamp or the third punch to separate the single-column strips into the individual battery cells. The third stamp and the third punch comprise a third base, a plurality of third blades in parallel with each other on the third base, and a plurality of third guides or pegs on the third base and completely outside all of the space between the outermost third blades. The third guides or pegs may be in locations on the third base identical to locations of the first or second guides or pegs on the first or second base, respectively. However, the third blades may oriented with respect to the third guides or pegs (or the single-column strips) orthogonally to an orientation of the plurality of first or second blades with respect to the second guides or pegs (or the columns of cells on the sheet, roll or strips).

In some embodiments, each of the second battery cell strips may be a single-column strip. In such embodiments, the method may further comprise placing the single-column strips and the second stamp or a second punch face-to-face, and applying sufficient pressure to at least one of (a) the single-column strips and (b) the second stamp or the second punch to singulate the single-column strips into the individual battery cells.

In some embodiments, each of the first battery cell strips comprises a plurality of columns of battery cells. In such embodiments, the method may comprise placing the first battery cell strips and the first stamp or punch face-to-face, and applying sufficient pressure to either the carrier or the first stamp or punch to separate the first battery cell strips into the second battery cell strips or the multi-cell units.

In embodiments in which the first battery cell strips are separated into the second battery cell strips or singulated into the multi-cell units, the first battery cell strips may include from two to eight columns and/or from two to 50 (e.g., 4-45, 6-30, 8-20, or any other range therein) rows of battery cells. When the first stamp or punch separates the first battery cell strips into the second battery cell strips, each of the second battery cell strips may be a single-column strip. Thus, each of the single-column strips may include from two to 50 battery cells in a single row.

Alternatively, the first stamp or punch may singulate the first battery cell strips into the multi-cell units. In such alternative embodiments, each of the multi-cell units may include from two to eight battery cells in a single row, and the method may further comprise folding each of the multi-cell units to form a stack of battery cells.

In some embodiments, the method may further comprise placing the single-column strips and a second or third stamp or punch face-to-face, and applying sufficient pressure to at least one of the single-column strips and the second or third stamp or punch to singulate the single-column strips into the individual battery cells. As for the first and second stamps and punches, the third stamp or punch comprises a third base, a plurality of third blades in parallel with each other on the third base, and a plurality of third guides or pegs on the third base and completely outside all of the space between the outermost third blades.

Another aspect of the present invention relates to a method of assembling a multi-cell solid-state battery, comprising the present method of cutting or dicing solid-state battery cells (e.g., to form the individual battery cells), forming a battery cell stack from the plurality of multi-cell units or the plurality of individual battery cells, placing air and water barriers on uppermost and lowermost surfaces of the stack, forming a first battery terminal on an ACC side of the individual battery cells in the stack, and forming a second battery terminal on a CCC side of the individual battery cells in the stack to form the multi-cell solid-state battery.

A further aspect of the present invention relates to a stamp or punch for cutting or dicing solid-state battery cells, comprising a first base, a plurality of first blades in parallel with each other on the first base, a plurality of first guides or pegs on the base and completely outside all of the space between the outermost first blades, and a plurality of blade guides on the base, such that each of the blades has at least one blade guide at an end of the blade. The solid-state battery cells are in an array of rows and columns on a substrate, and form a sheet, a roll or a plurality of first strips. A space between adjacent columns or adjacent rows defines a dicing channel (e.g., in the sheet, roll or first strips). The first strips are on a carrier. The blade guides are configured to align the blades with each other and/or with at least some of the dicing channels. The stamp or punch is configured to separate the sheet, the roll or the first strips into a second plurality of strips, a plurality of multi-cell units, or a plurality of individual battery cells upon application of sufficient pressure to at least one of (a) the sheet, the roll or the carrier and (b) the stamp or punch.

In some embodiments, adjacent first blades are spaced apart by n times a width or length of the solid-state battery cell, and n is a positive integer. In other or further embodiments, each of the first blades has a first blade guide at one end of the blade, and a second blade guide at an opposite end of the blade.

In some embodiments, the guides or pegs comprise a first guide or peg, a second guide or peg, a third guide or peg, and a fourth guide or peg. The first guide or peg may be separated (i) along a first direction from the second guide or peg by a first distance, and (ii) along a second direction from the third guide or peg by a second distance. The first distance may differ from the second distance, and the first direction may be orthogonal to the second direction.

A still further aspect of the present invention relates to a set of stamps or punches for cutting or dicing solid-state battery cells, comprising the present stamp or punch, and a second stamp or punch. The second stamp or punch comprises a second base, a plurality of second blades in parallel with each other on the second base, a plurality of second guides or pegs on the base and completely outside all of the space between the outermost second blades, and a plurality of second blade guides on the second base, such that each of the plurality of second blades has at least one of the plurality of second blade guides at an end of the second blade.

For cutting or dicing by the second stamp or punch, the solid-state battery cells are on a plurality of second strips on a second carrier. The second strips generally include the same number of rows as the sheet, roll or first strips, and one or more columns, but a smaller number of columns than the sheet, roll or first strips. The second stamp or punch is configured to (i) separate the second plurality of strips into a plurality of single-column strips, a second plurality of multi-cell units or the plurality of individual battery cells or (ii) singulate the multi-cell units (separated by the prior/first stamp or punch) into the individual battery cells upon application of sufficient pressure to at least one of (a) the second carrier and (b) the second stamp or punch.

In some embodiments of the set of stamps or punches, the second guides or pegs may be in locations on the second base identical to locations of the guides or pegs on the first base, the second blades may be oriented identically or orthogonally to an orientation of the first blades with respect to columns of battery cells or the guides or pegs, and/or the second blades may be in locations on the second base that are offset from locations of the first blades on the first base.

In some embodiments, the set of stamps or punches may further comprise a third stamp or punch. The third stamp or punch may comprise a third base, a plurality of third blades in parallel with each other on the third base, a plurality of third guides or pegs on the third base and completely outside all of the space between the outermost third blades, and a plurality of third blade guides on the third base, such that each of the third blades has at least one of the third blade guides at an end of the third blade. The third stamp or punch is configured to singulate the single-column strips into the individual battery cells upon application of sufficient pressure to at least one of the third carrier and the third stamp or punch. In the set of stamps or punches, the first through third stamps or punches may be constructed similarly to each other, except for the orientation and length of the blades, the number of blades, and the spacing between adjacent blades.

Other capabilities and advantages of the present invention will become readily apparent from the detailed description of various embodiments below.

### BRIEF DESCRIPTION OF THE DRAWINGS

FIGS. 1A6A are cross-sectional views and FIGS. 1B-6B are corresponding top-down views of structures in an exemplary process of manufacturing a solid-state battery cell.

FIGS. 7A-C are views of an exemplary stamp or punch for cutting sheets or rolls of solid-state battery cells into strips of cell pairs according to embodiments of the present invention.

FIG. 8A-B are views of an exemplary stamp or punch complementary to that shown in FIGS. 7A-C for singulating the solid-state battery cells according to embodiments of the present invention.

FIG. 9 is a cross-sectional view of an unpackaged stack of solid-state battery cells, according to one or more embodiments of the present invention.

FIG. 10 is a cross-sectional view of a packaged solid-state battery, according to one or more embodiments of the present invention.

FIG. 11 is a flow chart for exemplary methods of separating or singulating solid-state battery cells from a sheet or roll containing an array of battery cells thereon, in rows and columns, into individual battery cells or multi-cell units.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. Furthermore, it should be understood that the possible permutations and combinations described herein are not meant to limit the invention. Specifically, variations that are not inconsistent may be mixed and matched as desired.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

For the sake of convenience and simplicity, the term “length” generally refers to the largest dimension of a given 3-dimensional structure or feature. The term “width” generally refers to the second largest dimension of a given 3-dimensional structure or feature. The term “thickness” generally refers to a smallest dimension of a given 3-dimensional structure or feature. The length and the width, or the width and the thickness, may be the same in some cases. A “major surface” refers to a surface defined by the two largest dimensions of a given structure or feature, which in the case of a structure or feature having a circular surface, may be defined by the radius of the circle.

In addition, for convenience and simplicity, the terms “part,” “portion,” and “region” may be used interchangeably but these terms are also generally given their art-recognized meanings. Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

The following discussion provides examples of solid-state batteries, stacked solid-state batteries, and processes for manufacturing such batteries.

### An Exemplary Method of Singulating Solid-State Batteries

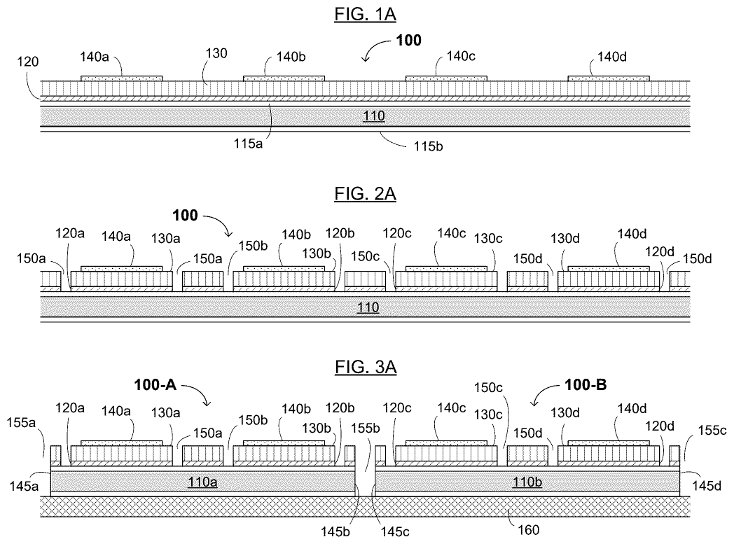

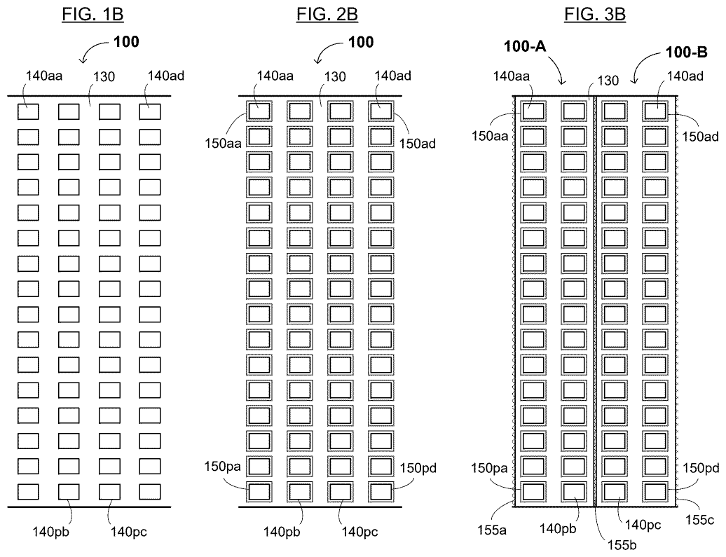

FIG. 1A shows a cross-section of a sheet or roll 100 of solid-state lithium battery cell layers on a substrate 110. The substrate 110 may comprise a foil or film of a metal or metal alloy, such as stainless steel, copper, titanium or aluminum. The foil or film 110 may have a thickness of 0.1-1000 μm (e.g., 1-500 μm or any value therein, such as 10-100 μm), but is typically in the range of 100-300 μm at this stage of processing. Optional first and second barriers 115a-b may be on opposite major surfaces of the substrate 110, although when the substrate 110 is a film, the second barrier 115b may be a mechanical support (e.g., a plastic film, sheet or roll, or a ceramic sheet). A cathode layer 120 is on the first barrier 115a, a solid-state electrolyte layer 130 is on the cathode layer 120, and anode current collector (ACC) layers 140a-d are on the electrolyte layer 130, thus forming substantially complete (but unsealed) cells. A separately-formed anode is not necessary in solid-state lithium batteries, as a lithium anode can be formed between the electrolyte 130 and the anode current collectors 140a-d during charging, if necessary. Optionally, however, a thin lithium anode can be deposited by evaporation onto the electrolyte 130 prior to formation of the anode current collectors 140a-d.

The anode current collectors 140a-d generally comprise a conductive metal, such as nickel, zinc, copper, alloys thereof (e.g., NiV), etc., or another conductor, such as graphite. The anode current collectors 140a-d can be selectively deposited by screen printing, inkjet printing, spray coating, extrusion coating, etc., or formed by blanket deposition (e.g., sputtering or evaporation) and patterning (e.g., low-resolution photolithography, development and etching). The anode current collectors 140a-d may have a thickness of 0.1-5 μm, although it is not limited to this range.

FIG. 1B shows an embodiment in which individual anode current collectors 140aa-pd are in each cell of the sheet or roll 100. The cells may be organized in rows (e.g., rows a-p as shown in FIG. 1B) and columns (e.g., columns a-d as shown in FIG. 1B). Alternatively, the anode current collectors may first be formed as strips, and the strips may be separated into individual cells in the second stamping process discussed herein. In the example shown in FIG. 1B, the individual anode current collectors 140a-d may have area dimensions (i.e., length and width dimensions) that are 50-90% of the corresponding length and width dimensions, respectively, of the cell (see e.g., FIGS. 6A-B). The borders of the anode current collectors 140aa-pd may be offset (pulled back) a minimal distance from the ultimate cell borders, in some embodiments. The pull-back distance of the ACCs 140aa-pd from the cell edges should be sufficient to electrically isolate the ACCs 140aa-pd from the CCC/substrate 110. Formation of the anode current collectors 140aa-pd substantially completes formation of the active cells, except for routing the current at/on the anode current collectors 140aa-pd to a battery terminal.

The cells may further include one or more interlayers that modify the interfaces between layers. For example, a metal oxide (e.g., Nb₂O₅, Al₂O₃, Li₄Ti₅O₁₂ or LiNbO₃) interlayer may be formed on the cathode 120 prior to deposition of the electrolyte 130 (e.g., to reduce interfacial stress, decrease interfacial resistance, or suppress formation of a space charge layer). An amorphous (e.g., elemental silicon) interlayer may be deposited on the electrolyte 130 prior to formation of the anode current collectors 140a-d to inhibit reduction of the electrolyte. Of course, the battery cell can be made in the reverse order (i.e., the anode current collector may be first formed on the substrate, then the remaining layers deposited in reverse order thereon).

An advantage of the present method is that some or all of the active battery layers (e.g., the cathode 120 and the solid-state electrolyte 130) are deposited as blanket layers. This maximizes the active area utilization of the battery cells for high intrinsic capacity, and also results in a topographically planar or “flat” cell to facilitate formation of the uppermost layer(s) and downstream packaging due to the pattern-free blanket-deposited layers. However, if necessary or desired, the cathode 120 and the SSE 130 can be slightly pulled back from the cell edge by subtractive patterning (e.g., low-resolution photolithography, laser ablation) or selective deposition (as described herein).

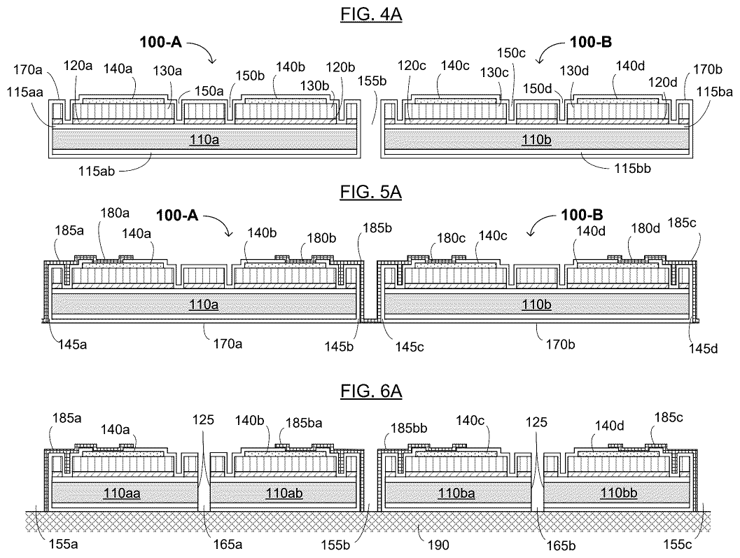

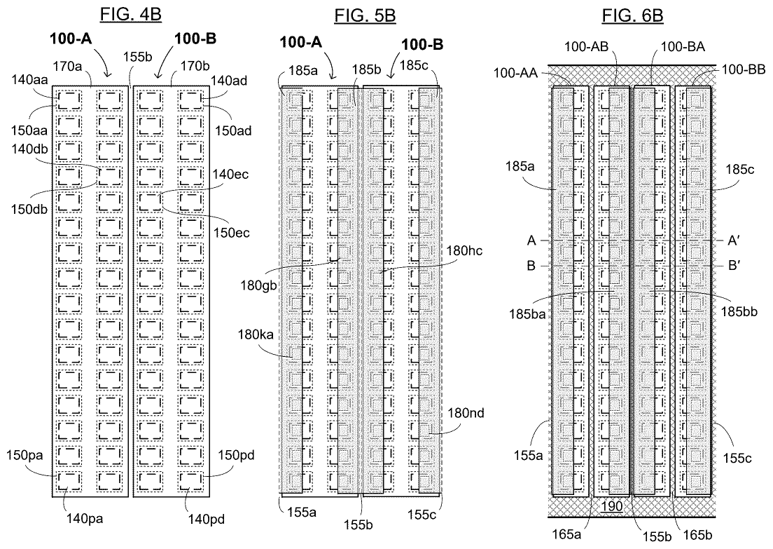

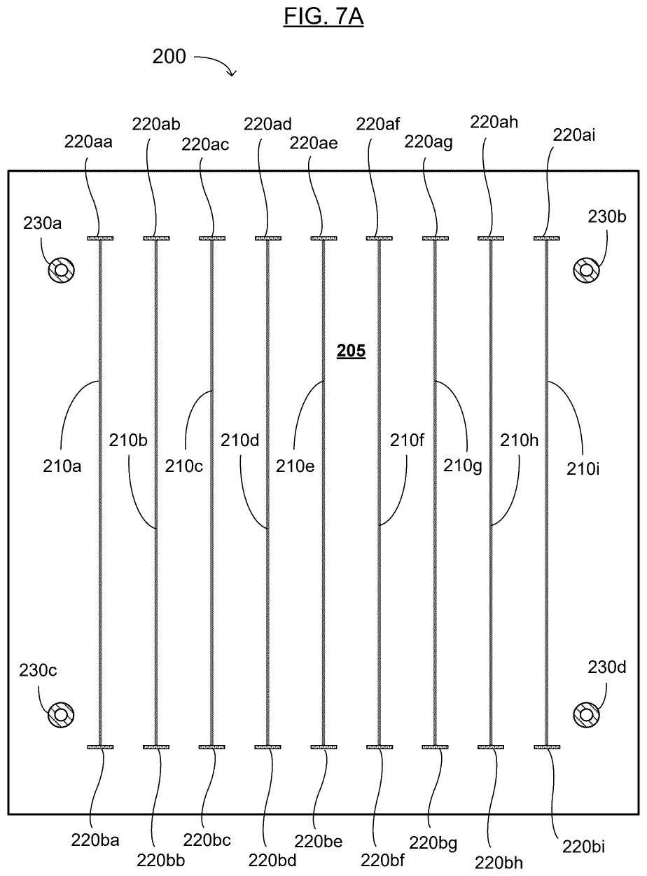

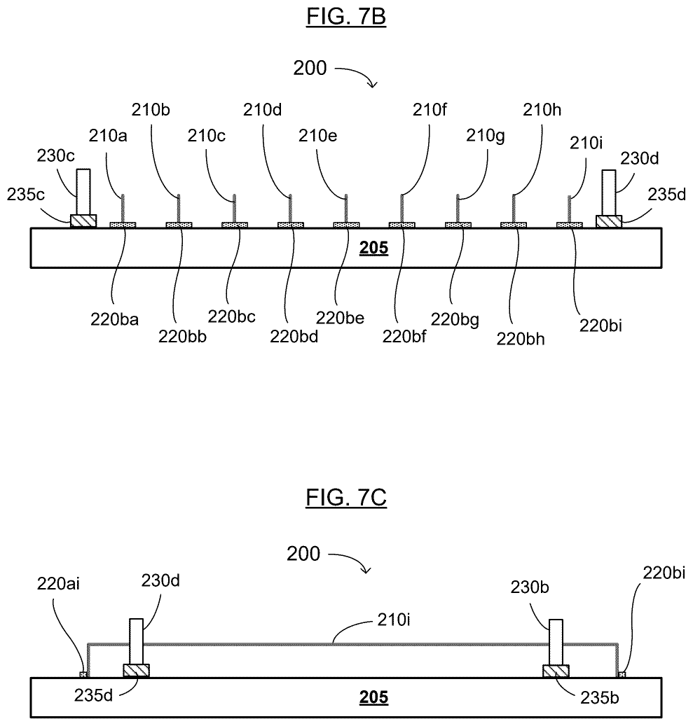

FIGS. 2A-6B show structures in a process for moat formation, ACC-edge electrical isolation and cell encapsulation, followed by formation of an interconnect/via and redistribution layer for contact with the anode current collector 140. After cell fabrication as described above, FIG. 2A show the devices receiving a shallow cut 150a-d through both of the cathode layer 120 and the solid-state electrolyte layer 130 (and optionally slightly into the first barrier 115a) outside of the ACCs 140a-d to form moats 150a-d. As shown in FIG. 2B, the moats 150aa-pd may completely surround the respective ACCs 140aa-pd. Alternatively, when the ACCs 140a-d are deposited or otherwise formed as strips, the moats 150 may be formed in parallel outside of the ACC strips 140a-d, along the length of the ACC strips 140a-d. The moats 150aa-pd may be formed by laser ablation, mechanical dicing, or low-resolution photolithographic patterning (e.g., of a photoresist or other mask) and etching. The moats 150aa-pd may have a width of 3-20 μm, although the invention is not limited to such widths. The moats 150aa-pd provide an anchoring feature for cell encapsulation (see the discussion below with regard to FIG. 7) and physically separate the active portion(s) of the battery layers from a peripheral dummy region. When the moats 150aa-pd extend into the first barrier 115a, they fully isolate the active cathode and electrolyte layers 120 and 130. Each of these aspects of the moats 150 increases resistance to ambient ingress.

Referring to FIG. 3A, the sheet or roll 100 is attached to a tape or sheet 160, and the electrolyte 130, the cathode 120 and the substrate 110/115a-b are cut or diced between alternating pairs of columns to form an opening 155a-c between every other column of cells, exposing the “ACC edges” 145a-d of the battery cells and forming strips 100-A and 100-B of cell pairs. Alternatively, when the cells are in a sheet, the openings 155 may be made between every other column or every other row of cells, both of which result in cell pair strips.

The tape or sheet 160 is generally a UV release tape or sheet, containing an adhesive on one or both major surfaces that loses its adhesive properties upon sufficient irradiation with ultraviolet (UV) light. The tape or sheet 160 may be on a ring, frame, or other mechanical support (not shown), which may be configured to allow some tension in the tape or sheet 160. The openings 155a-c may be formed by stamping, for example using the stamp 200 of FIGS. 7A-C (described below). The mechanical stamp 200 cuts through the material in the dicing street (i.e., the locations along which the openings 155a-c are formed) by compressive force. Thus, the mechanical support for the tape or sheet 160 may have openings therein configured to align the sheet or roll 100 with the blades on the stamp, and may be similar to the carrier 190 in FIGS. 6A-B. Consequently, the blades 210 on the stamp 200 (FIGS. 7A-B) may be aligned in the space between adjacent cells on the sheet or roll 100. Referring back to FIG. 3A, the sidewalls 145a-d along the openings 155a-c fully expose the entire cell stack, including the CCC/substrate 110. The CCC/substrate 110 is electrically passivated (FIGS. 4A-B) prior to formation of ACC redistribution traces 185a-c (FIGS. 5A-B) along the sidewalls 145a-d, for electrical connection to the ACCs 140a-d through laser vias 180a-d.

Referring now to FIGS. 4A-B, after the stamped cell pair strips 100-A and 100-B are released from the tape or sheet 160, the cell pairs are encapsulated with a mechanically compliant moisture barrier and electrical insulation film 170a-b. FIG. 4A shows a cross-section of strips 100-A and 100-B of cell pairs prepared according to U.S. patent application Ser. No. 18/319,532 and U.S. Prov. Pat. Appl. No. 63/343,522 (Atty. Docket Nos. IDR2022-02 and IDR2022-02-PR, respectively, filed May 18, 2023 and May 18, 2022, respectively, the relevant contents of each of which are incorporated herein by reference). Alternatively, the cell pairs may be prepared according to U.S. patent application Ser. No. 18/319,552 and U.S. Prov. Pat. Appl. No. 63/343,526 (Atty. Docket Nos. IDR2022-03 and IDR2022-03-PR, respectively, filed May 18, 2023 and May 18, 2022, respectively, the relevant contents of each of which are incorporated herein by reference). Each cell pair includes the metal foil, sheet or film substrate 110a-b with optional first and second barriers 115aa-bb on opposite major surfaces thereof, cathodes 120a-d on the first barrier 115aa, solid-state electrolyte layers 130a-d on the cathodes 120a-d, ACCs 140a-d on the electrolyte layers 130a-d, and optional moats 150a-d that completely surround the respective ACCs 140a-d in each cell. Each of the metal substrates 110a-b also serves as a cathode current collector (CCC) for the corresponding cell(s).

The strips 100-A and 100-B of cell pairs are encapsulated with a mechanically compliant moisture barrier and electrical insulation film 170a-b. The barrier/insulation film 170a-b also lines the inner surfaces of the moats 150a-d (when present) to provide further electrical isolation and moisture barriers to protect the battery cells. The barrier/insulation film 170a-b may comprise parylene, polyethylene, polypropylene, or another polyolefin, with or without a thin inorganic oxide or nitride overlayer such as Al₂O₃, SiO₂ or Si₃N₄ (e.g., a parylene/Al₂O₃ bilayer). Additionally, the barrier/insulation film 170a-b may be coated with a polycarbonate or a diamond-like (e.g., amorphous carbon) coating for additional mechanical protection. Alternatively, encapsulation with the moisture barrier and electrical insulation film 170a-b may be performed after dicing the strips of cell pairs into individual cell pairs and optionally releasing the cell pairs from a tape or sheet (not shown). The barrier/insulation film 170a-b thus may cover all exposed front, back and side surfaces of the cell pairs or strips of cell pairs. The barrier/insulation film 170a-b may be formed by pyrolysis, thermal CVD, ALD, inkjet printing, or screen printing.

The cell pair strips 100-A and 100-B are more clearly seen in FIG. 4B, with stamped opening 155b between the strips. Each cell pair strip 100-A includes a plurality of cell pairs, with the ACCs 140xa-xb and the moats 150xa-xb (x is the row label a through p) shown in dashed lines, as they are covered by the insulation film 170a. Similarly, each cell pair strip 100-B includes a plurality of cell pairs, with the ACCs 140xc-xd and the moats 150xc-xd (x is the row label a through p) shown in dashed lines, as they are covered by the insulation film 170b.

Referring now to FIGS. 5A-B, redistribution metal layers 185a-c are formed on and along the “ACC sides” of the cell pairs exposed by the openings 155a-c and in vias or openings 180a-d in the barrier/insulation films 170a-b. The redistribution metal layers 185a-c connect the ACCs 140a-d to a subsequently formed external battery terminal. The vias or openings 180a-d may be formed in the barrier/insulation films 170a-b by (i) laser ablation or (ii) masking and etching. Alternatively, the vias or openings 180a-d may be formed by patterned encapsulation/deposition (e.g., printing) of the material(s) for the barrier/insulation films 170a-b on the upper surface of the cells. The redistribution layers 185a-c may comprise Cu, Ni, Al, or another suitable metal, and may be formed by sputtering or thermal evaporation (e.g., through a mask that exposes a region of the cell corresponding to the pattern of the redistribution layers 185a-c), followed by removal of the mask, or by selective deposition, such as inkjet printing, aerosol-jet printing, screen printing, extrusion coating, etc. As shown in FIG. 5B, single redistribution layer (e.g., 185b) is on the ACC edges (e.g., 145b-c) of adjacent cells in different strips (e.g., 110-A and 100-B). Alternatively, the redistribution layers 185 can be formed in only the adjacent cell pairs (e.g., containing ACCs 140ab-ac, 140bb-bc, etc.) by selective deposition. However, it is advantageous for the redistribution layers 185 to completely cover the vias or openings 180. The redistribution layers (or ACC traces) 185a-c go from the ACCs 140a-d or 140aa-pd exposed through the vias or openings 180a-d or 180aa-pd to the ACC edges 145a-d, in the opposite direction from the CCC edges 125 (see FIGS. 5A-6A).

The ACC redistribution traces 185a-c electrically contact the ACCs 140a-d through the vias 180a-d, but are physically and electrically insulated from the CCCs/substrates 110a-b by the barrier/insulation films 170a-b. When the ACC redistribution traces 185a-c are a metal or alloy (e.g., an amorphous alloy), they form an intrinsic barrier to ambient ingress in the region of the vias or openings 180a-d/180aa-pd. The ACC redistribution traces 185a-c are both physically on the top surface of the cell and covering at least part of the corresponding sidewalls 145a-d. The ACC redistribution traces 185a-c on the sidewalls 145a-d enable electrical connection to the cells through a terminal on the side of the battery at a later stage of the method.

Cell singulation by stamping is performed next, using a stamp (e.g., a parallel punch die, such as the punch die 200 shown in FIGS. 7A-C, with the blades having the same spacing therebetween, but offset from the positions shown in FIGS. 7A-B by one cell pitch, width or length) on a hard magnetic substrate carrier or base that can sustain the punch force from the stamp. The punch die 200 cuts the sections or strips of battery cell pairs (e.g., 100-A and/or 100-B in FIG. 5B) between the cells in each pair to form strips of individual cells 100-AA through 100-BB (FIG. 6B). Typically, there is no reduction in die density/unit area of substrate, as all of the substrate and substantially all of the active layers on or above the substrate are in the single cell strips. Referring to FIG. 6A, a magnetic carrier 190 may be configured to apply an electromagnetic force to hold the die (e.g., using the metal substrates 110), then to release the die after singulation (by deactivating or turning off the electromagnetic force) to enable a subsequent pick and place operation. The magnetic carrier 190 may also have holes or openings therethrough that complement the punch guides or pegs 230a-d on the punch die 200 (FIGS. 7A-C).

Referring to FIGS. 6A-B, the redistribution layer 185b may be cut or separated to form redistribution layers 185ba and 185bb prior to singulation (e.g., at or near the end of the redistribution layer formation process) or during singulation of the columns. The redistribution layers 185a and 185c may be similarly cut or separated in this process. The mechanical stamp or edges of the punch blades 210a-i (see FIGS. 7A-B) cut(s) through the material in the dicing street or lane by compressive force. Thus, the battery, encapsulant and any packaging layers (e.g., 110-170) in the dicing lanes are completely cut, while the remainder of the die (e.g., the battery cell pair [s]) remain unaffected. Due to this, UV tape and/or single-use carriers can be eliminated, thereby reducing material costs during manufacturing.

Laser cutting may also be used to singulate the individual battery cell strips 100-AA through 100-BB. Laser cutting cuts single “streets” 165a-b between die (e.g., forming rows, columns, or strips of cells) by destroying the material in the streets (e.g., the lanes between the rows, columns, or strips). As dies get smaller, the total street length increases, reducing throughput for a given unit area of microbattery die, and reducing efficiency (e.g., area of singulated die/area of substrate needed to make the singulated die).

FIGS. 7A-C show an exemplary stamp or punch 200, comprising a base 205, a plurality of blades 210a-i, two blade guides 220ax-bx for each blade 210 (x is the blade guide identifier corresponding to the blade identifier a through i), and a plurality of punch guides or pegs 230a-d. The base 205 comprises a material having sufficient rigidity and strength to withstand multiple, repeated punch operations. Typically, the base 205 comprises wood, a metal plate, a stiff plastic (e.g., a polycarbonate or polyurethane), or a combination (e.g., a laminate) thereof.

The blades 210a-i typically comprise a conventional metal blade capable of cutting a steel sheet or foil having a thickness of up to several hundred (e.g., 500) microns, although the metal substrates in the present battery are typically thinner than 100 microns. The blades 210a-i are spaced apart on the base 205 by n cell widths or cell lengths, where n is a positive integer, such as 1, 2, 3, etc. In the example shown in FIGS. 7A-C, n is 2. For example, adjacent ones of the blades 210a-i may be separated by 2-50 mm (or any distance or range of distances therein), although the invention is not limited to this range. Similarly, the blades 210a-i may have a length that is equal to or slightly greater than the corresponding dimension of the substrate being cut. The blades 210a-i may also have a width (or height) of 2-20 mm (or any width or range of widths therein), although the invention is not limited to this range. Optionally, the width (or height) of the blades 210a-i may be at least twice the maximum combined thickness of the substrate 110 and all layers thereon. The blades 210a-i may also have a thickness of 0.1-1.0 mm (or any thickness or range of thickness therein), although the invention is also not limited to this range. The thickness of the blades 210a-i may decrease at the uppermost edge (e.g., the blades 210a-i may be tapered and/or sharpened). The blades 210a-i may be sharpened between uses by one or more methods known in the art.

The blade guides 220aa-bi typically comprise a projection in one of a plurality of predetermined locations in the base 205. The blade guides 220aa-ai are spaced apart from the blade guides 220ba-bi by the length of the blades 210a-i, and ensure that the blades 210a-i are placed in the correct locations. For example, the blade guides 220aa-bi may comprise a small piece of metal (e.g., a staple or similar object) embedded in the base 205, and may include a mark or other indicator to show where the end of a corresponding blade 210x should be placed. The blade guides 220aa-bi may have a length of 2-10 mm (or any length or range of lengths therein), although the invention is not limited to this range. For example, there may be a single, continuous blade guide on each side of the blades 210a-i. The blade guides 220aa-bi may have a width of 1-5 mm (or any width or range of widths therein), although the invention is not limited to this range. The blade guides 220aa-bi may also have a thickness (or height above the base 205) of 0.5-3.0 mm (or any thickness or range of thickness therein), although the invention is also not limited to this range.

The punch guides or pegs 230a-d typically comprise a metal or stiff plastic cylinder having a diameter of 1.5 cm or less. The punch guides or pegs 230a-d may be secured to the base 205 with one or more threaded fittings 235a-d (which may have the thread [s] on an inner surface, in which case the thread [s] on the fittings 235a-d may mate with complementary groove [s] in a cylindrical base fitting secured to the base 205). Alternatively, the punch guides or pegs 230a-d may be secured to the base 205 with an adhesive, mechanical pressure (e.g., by placing the guide or peg 230 in a slightly smaller hole in the base 205), or a combination thereof. The punch guides or pegs 230a-d are inserted into corresponding holes on a mechanical carrier or the magnetic carrier 190 to ensure alignment of the blades 210 on the stamp 200 with the spaces or lanes between die in the sheet, roll or strip(s). When the substrate 110 is a sheet, the stamp or punch 200 has an area (width and length dimensions) greater than that of the sheet. When the substrate 110 is a roll, the stamp or punch 200 has a length (and optionally a width) greater than the width of the roll.

The punch 200 can cut either a single die or (more preferably) an area containing multiple dies, such as a row, column or strip (containing multiple rows and/or columns) of die. In some embodiments, the punch 200 is configured to cut sheets of die (comprising an n×m array of die, where n is the number of rows, m is the number of columns of die, and n and m are each an integer of 2, 3, 4 or more, up to 8, 10, 12, 16 or more). In further embodiments, such may be cut or sectioned from a roll. For example, ˜1000 8 mm×8 mm die may be within a 300 mm×300 mm sheet, or 250 8 mm×8 mm die may be within a 150 mm×150 mm area (e.g., taken from a 150 mm-wide roll). The punch 200 typically is configured to cut at least one dimension of an entire sheet in a single operation, and therefore typically has blades 210 longer than the dimension of the sheet to be cut.

In some embodiments, singulating by stamping is a two-step process. The first step cuts the sheet or roll along the length or width of the sheet (e.g., into individual columns) using a first punch with a first spacing between the blades, and the second step cuts the columns along the width into individual die/cells using a second punch with a second spacing between the blades. In a further embodiment, singulating by stamping may be a three-step process, in which the first step cuts the sheet or roll into multi-column strips (i.e., strips having the same number of rows as the sheet or roll, but only a relatively small number [e.g., 2-8] columns).

In the example shown in the Figures, the first cut may separate the sheet or roll 100 (see, e.g., FIGS. 2A-B) into strips containing 2 columns of cells, and the second cut may separate the multi-column strips 100-A and 100-B (see, e.g., FIGS. 5A-B) into individual columns of cells. Stamping between the moats 150 in adjacent cells forms the CCC edges 125 and openings 165a-c, and creates single columns of cells. The spacing between the blades in the punch or stamp for the first and second cuts is 2 times the length or width of the cells (i.e., the horizontal dimension shown in FIGS. 3A and 6A), plus the spacing between strips (e.g., the width of the gap in opening 165b). The third cut (or, when the first cut separates the substrate into individual columns, the second cut) cuts along the width of the strips, separating the columns of cells (i.e., the 1×n strips of cells) into individual cells. The spacing between the blades in the second punch is the other of the width or length of the cells (i.e., along the axis normal or perpendicular to the plane of the page in FIGS. 3A and 6A).

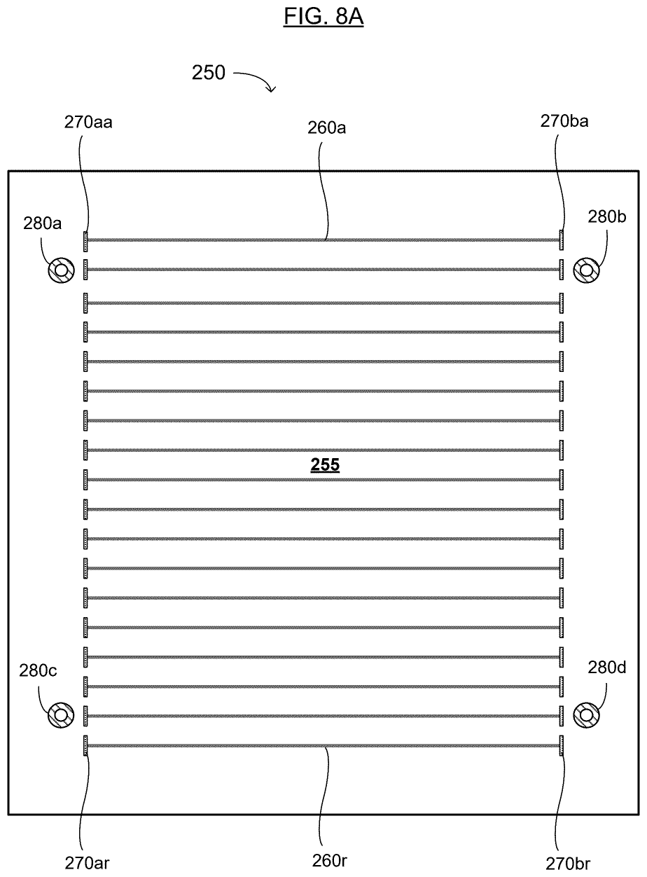

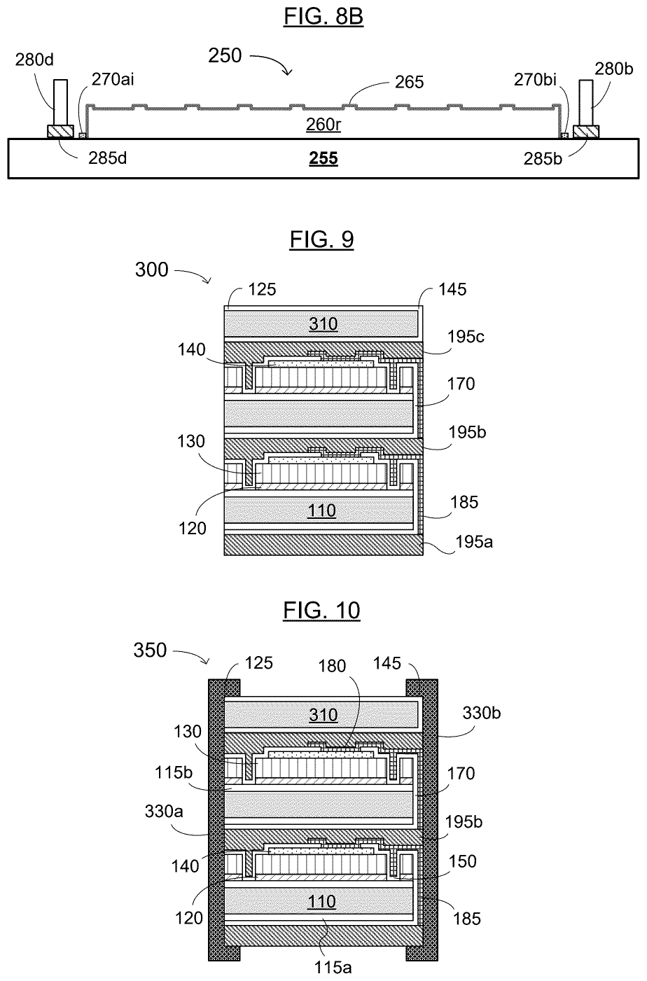

FIGS. 8A-B show a second punch 250 for use in the last step of the stamping process. The second punch 250 in FIGS. 8A-B cuts the dies along a direction orthogonal to that of the first punch 200. The base of the second punch 250 may have length and width dimensions substantially identical to those of the first punch 200, and the punch guides or pegs 270 on the second punch 250 may be in locations identical to the punch guides or pegs 230 on the first punch 200.

The blades 260a-r on the second punch 250 have a length slightly greater than the width of the sheet (or the combined widths of the strips) being cut, and the spacing between adjacent blades 260a-r on the second punch 250 differs from that between the blades 210a-i on the first punch 200. For example, the spacing between adjacent blades 260a-r may be about the same as the width or length of an individual cell. The blades 260a-r may also have optional raised sections 265 along the cutting edge. The raised sections 265 may extend by 0.1-2 mm beyond the non-raised sections of the blades 260a-r, and may be aligned with either the openings 155 or the openings 165. The blades 260a-r on the second punch 250 may be aligned and/or held in place using blade guides 270aa-br.

The extension distance of the raised sections 265 may be equal to or greater than the thickness of the dies in the dicing lanes of the columns of cells (e.g., along the lines A-A′ and B-B′ in FIG. 6B). The raised sections 265 may have a length (i.e., along a horizontal [x-axis] direction in the plane of the page in FIG. 8B) equal to or less than the width of the strips 100-AA through 100-BB, but typically >50% of the width of the strips 100-AA through 100-BB. The dicing lanes have a length equal to the width of the strips 100-AA through 100-BB, but the raised sections 265 can effectively singulate the die when the length of the raised sections 265 is between 50% and 100% of the width of the strips 100-AA through 100-BB, as the force of the raised sections 265 cutting through the dicing lanes either separates any remaining parts of the dicing lanes not contacted by the raised sections 265 or the blade 260, or weakens it sufficiently that it can be easily separated from any connected die (e.g., manually, or in subsequent processing).

Due to the electromagnetic force from the magnetic carrier 190, the dies having a magnetic substrate material (e.g., steel) are held in place on the magnetic carrier 190 while stamping with the second punch or stamp 250, with no adhesive required. This eliminates the risks of residue remaining on the backside of the dies and mechanical damage to the thin substrate with (even thinner) ceramic layers thereon that constitute the battery cell stack.

The singulated die on the carrier 190 can now be handled in a subsequent pick and place operation, where the dies are released and subsequently stacked (e.g., in a predetermined integer number, generally from 2 to 8) for packaging. However, stacking methods other than pick and place, such as strip folding, strip stacking, etc. (see, e.g., U.S. patent application Ser. No. 17/185,122, filed Feb. 25, 2021 [Attorney Docket No. IDR2020-02], and U.S. Provisional Pat. Appl. No. 63/598,912, filed Nov. 14, 2023 [Attorney Docket No. IDR2022-10-PR], the relevant portions of each of which are incorporated herein by reference), are also acceptable. In some embodiments of strip folding, the stamping process to singulate individual columns or rows of cells into individual cells is not necessary, and the individual columns or rows of cells may be folded into a stacked battery, with all exposed CCC surfaces of the substrate 110 on one side of the stack, and all ACC surfaces of the redistribution layer 185 on the opposite side of the stack.

Following singulation, but prior to stacking, an adhesive (e.g., epoxy) coating 195 (see FIG. 9) may be applied by conventional techniques (e.g., printing, coating, spraying, etc.) to the top and/or bottom major surface of the die to ensure stability of the stacked dies. The adhesive coating 195 may also provide a passivation and/or sealing layer on the major surfaces of the cells during packaging and assembly. The epoxy adhesion 195b-c between cells can be applied to the back and/or front major surface of the cells by well-known methods, such as b-stage laminated film formation, dispensing, jetting, inkjet printing, screen printing, etc.

A dummy cell 310 (e.g., a metal foil substrate encapsulated with one or two barrier layers as described herein) may be placed on top of the stack 300 as a moisture and air barrier and to protect the stack 300 from externally-caused damage. Optionally, markings on one major surface of the dummy cell 310 can be used as external product markings.

As shown in FIG. 9, the stack of singulated cells 300 has a CCC (substrate) side or edge 125 of the cell, and an ACC side or edge 145 (including the ACC trace/redistribution layer 185) along the opposite side of the cell. The cells in the stack 300 are secured to one or more adjacent cells by the adhesive 195. The stack of cells 300 forms a solid-state battery. The parallel cells each additively contribute to the overall battery capacity.

FIG. 9 shows a cross-section of an exemplary unpackaged solid-state battery 300. The unpackaged battery 300 includes a plurality of cells, each comprising a cathode current collector 110, a cathode 120 (e.g., LCO) on the cathode current collector (CCC) 110, a solid-state electrolyte 130 on the cathode 120, an anode current collector (ACC) 140 on the electrolyte 130, a barrier/insulation film 170 with a via or opening 180 therein exposing the ACC 140, and a conductive redistribution layer 185 in the via or opening 180 and on the barrier/insulation film 170. The redistribution layer 185 is also on a first sidewall (the ACC edge 145) of the cell. Thus, as shown in FIG. 9, stacking forms a multi-layer set of parallel cells 300 with the CCC (substrate) edges 125 along one side of the stack, and the ACC edges 145 (including the ACC trace/redistribution layers 185) along the opposite side.

In some embodiments, a thin stainless-steel (SS) substrate 110 serves as the cathode current collector. In such embodiments, there is no need for a separate CCC layer, which consumes space in the battery 300 and increases the complexity of manufacturing the battery. Stainless steel is mechanically strong, and therefore, its thickness can be minimized (e.g., to 3-50 μm) to maximize cell energy density. The substrate 110 can be further encapsulated by a barrier metal 115a-b to suppress diffusion of metal atoms from the substrate to the cathode 120 (as well as any other overlying or underlying battery layer).

In some embodiments, the battery cells include an anode-free ACC 140, which may be defined with minimal pull-back from the cell edges or the moat 150. The corresponding moat-less cells (as disclosed in U.S. patent application Ser. No. 18/319,552, filed May 18, 2023 [Attorney Docket No. IDR2022-03], the relevant portions of which are incorporated herein by reference) maximize area utilization. Furthermore, the use of an underlying blanket cathode 120 and a blanket solid-state electrolyte 130 results in a flat or planar ACC 140, which minimizes mechanical stresses from Li plating and/or stripping during cell cycling.

To form the completed battery, the external battery terminals are formed by coating the battery ends with a conductive epoxy, and optionally, plating the coated ends with a metal or other conductor. Battery terminal dipping and plating the stacked set of cells 300 forms a packaged battery 350 with external electrical contacts 330a-b, as shown in FIG. 10. End terminals at the CCC and ACC edges 125 and 145 (e.g., the exposed edges of the CCCs 110 and the redistribution layers 185, respectively) are dipped into or coated with a conductive epoxy to electrically gang the terminals and form the CCC terminal 330a and ACC terminal 330b of the packaged battery. The conductive epoxy may comprise an Ag-filled or Ni-filled conductive epoxy paste. Alternatively, a pin-to-pin paste transfer method may be used, or a stable and/or noble metal such as Au, Pt, Pd or Cu can be used in place of the Ag or Ni. Plating part or all of the CCC terminal 330a and ACC terminal 330b creates a solderable surface for PCB attachment by the end user. For solderable termination, the epoxy surface may be plated with Ni, Ag, In, Sn, or a combination thereof (e.g., Ni, then with In or Sn).

In some embodiments, the conductive epoxy 330a-b contains a relatively high metal content, which can retard ambient ingress (e.g., of oxygen or water vapor). Plating the epoxy 330a-b with one or more pure metal layers may further block ambient ingress. Both of these features help with ambient air resistance, particularly on the CCC edge 125, due to the barrier/insulation film 170 being diced at this edge during cell singulation.

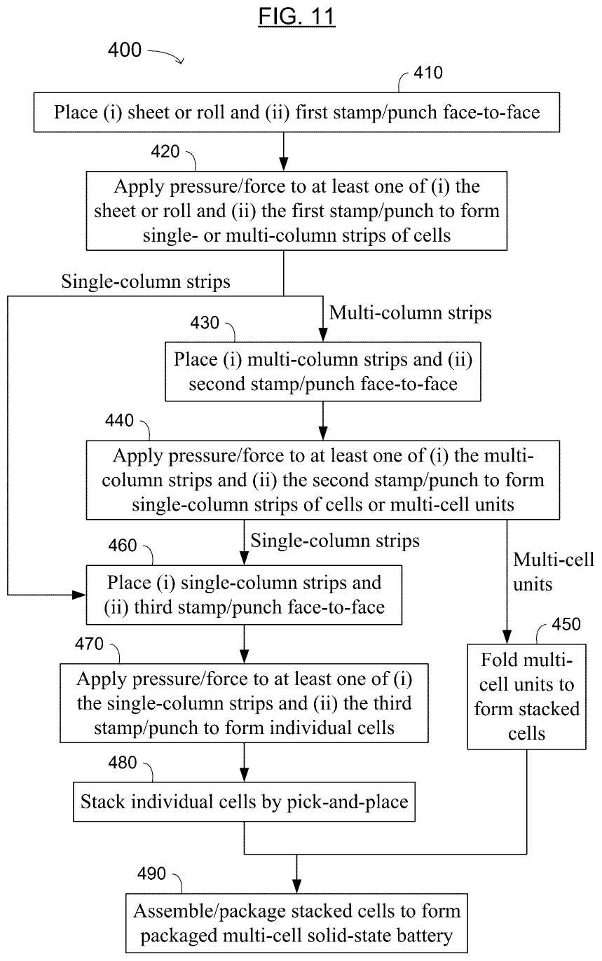

FIG. 11 shows a flow chart 400 for exemplary methods of separating or singulating solid-state battery cells from a sheet or roll containing an array of battery cells thereon, in rows and columns, into individual battery cells or multi-cell units. In a first step 410, the sheet or roll (e.g., a section 100 of which is shown in FIGS. 2A-B) and the stamp or punch (e.g., punch 200 shown in FIGS. 7A-C) are brought face-to-face in a stamping or punching apparatus (not shown). In the exemplary methods described herein, the ACCs (e.g., 140) on the sheet or roll face the blades (e.g., the cutting edges thereof) on the stamp or punch when face-to-face.

The stamping or punching apparatus may include a flat, mechanically rigid surface supporting the sheet or roll (which may be on a tape or release sheet 160; see FIG. 3A) and a cylinder or arm to which the stamp or punch is affixed, configured to apply a sufficient force to the stamp or punch to cur or otherwise separate the sheet or roll into strips. The strips may contain a single column or multiple columns of battery cells. Alternatively, the stamp or punch may be fixed to a rigid support, and the stamping or punching apparatus may apply the force (or an equivalent pressure) to the backside of the mechanical surface supporting the sheet or roll, or the stamping or punching apparatus may apply the force or pressure to both (i) the stamp or punch and (ii) the sheet or roll. Thus, at 420, the method then applies a pressure or force to at least one of (i) the sheet or roll and (ii) the first stamp/punch to form single-or multi-column strips of solid-state battery cells.

When the method forms multi-column strips of battery cells, the multi-column strips may be further processed (e.g., encapsulated with an insulator 170 and/or having a redistribution layer 185 formed thereon; see FIGS. 4A-5B), then are placed face-to-face with a second stamp or punch for additional separation or singulation at 430. The second stamp or punch may be similar or identical to the first stamp or punch, but with the second blades offset from the first blades (e.g., relative to the punch guides or pegs) and/or in a greater number than (e.g., a positive integer multiple of) the first blades. In an alternative method, the multi-column strips may be separated into single-column strips by laser dicing or cutting, as described herein.

At 440, a sufficient pressure or force is then applied to at least one of (i) the multi-column strips and (ii) the second stamp or punch to form single-column strips or multi-cell units of solid-state battery cells. The multi-cell units are single rows of solid-state battery cells from the multi-column strips, and may contain from two to eight cells, although the invention is not limited to a maximum number of eight cells in a multi-cell unit. The multi-cell units may be suitable for use in a method of making stacked solid-state batteries in which the stack of solid-state battery cells is formed by folding at 450 (see, e.g., U.S. Provisional Pat. Appl. No. 63/598,912, filed Nov. 14, 2023 [Attorney Docket No. IDR2022-10-PR], the relevant portions of which are incorporated herein by reference).

When the method forms single-column strips of battery cells (e.g., at either 420 or 440), the single-column strips of cells (see, e.g., strips 100-AA through 100-BB in FIG. 6B), are placed face-to-face with a third stamp or punch for singulation at 460. The third stamp or punch may be similar to the first and/or second stamps or punches (e.g., the guides or pegs on the third stamp or punch may be in identical locations to those on the first and/or second stamps or punches), but the blades are generally oriented orthogonally to the blades on the first and/or second stamps or punches (e.g., with respect to the punch guides or pegs when they are in the same locations, and adjacent guides or pegs have different distances between them, or with respect to the orientation or direction of the columns of cells on the sheet, roll, or strips).

At 470, a sufficient pressure or force is then applied to at least one of (i) the single-column strips and (ii) the third stamp or punch to form individual solid-state battery cells. The individual battery cells are then stacked (for subsequent assembly) using a conventional pick-and-place operation at 480. The stacked battery cells are then assembled and/or packaged at 490 to form packaged multi-cell solid-state batteries, as described herein with respect to FIG. 10.

### CONCLUSION

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

1. A method of cutting or dicing solid-state battery cells, comprising:
placing (i) a sheet, a roll or a first plurality of battery cell strips and (ii) a first stamp or a first punch face-to-face, wherein:
the sheet, the roll and the first plurality of battery cell strips comprise a substrate and a plurality of cells thereon in an array of rows and columns, and the first plurality of battery cell strips are on a carrier;
each of the cells comprises a cathode on or over the substrate, a solid-state electrolyte on the cathode, and an anode current collector (ACC) on the electrolyte; and
the first stamp and the first punch comprise a first base, a plurality of first blades in parallel with each other on the first base, and a plurality of first guides or pegs on the base and completely outside all space between the outermost ones of the plurality of first blades; and
applying sufficient pressure to at least one of (a) the sheet, the roll or the carrier and (b) the first stamp or the first punch to separate:
the sheet or the roll into a second plurality of battery cell strips, or
the first plurality of battery cell strips into a third plurality of battery cell strips, a plurality of multi-cell units, or a plurality of individual battery cells.

2. The method of claim 1, wherein the stamp and the punch further comprise a plurality of blade guides on the base, the plurality of blade guides being configured to align the plurality of blades with each other and/or with dicing channels on or in the sheet, the roll and/or the first plurality of battery cell strips, and each of the plurality of blades having at least one of the plurality of blade guides at an end of the blade.

3. The method of claim 1, comprising:
placing (i) the sheet or the roll and (ii) the first stamp or the first punch face-to-face; and
applying sufficient pressure to at least one of (a) the sheet or the roll and (b) the first stamp or the first punch to separate the sheet or the roll into the second plurality of battery cell strips.

4. The method of claim 3, wherein each of the second plurality of battery cell strips comprises from two to eight columns of battery cells.

5. The method of claim 3, further comprising:
placing (i) the second plurality of battery cell strips and (ii) a second stamp or a second punch face-to-face, wherein the second stamp and the second punch comprise a second base, a plurality of second blades in parallel with each other on the second base, and a plurality of second guides or pegs on the second base and completely outside all space between the outermost ones of the plurality of second blades; and
applying sufficient pressure to at least one of (a) the second plurality of battery cell strips and (b) the second stamp or the second punch to separate the second plurality of battery cell strips into a plurality of single-column strips.

6. The method of claim 5, wherein the second guides or pegs are in locations on the second base identical to locations of the first guides or pegs on the first base, and the plurality of second blades are oriented with respect to the second guides or pegs identically to an orientation of the plurality of first blades with respect to the first guides or pegs.

7. The method of claim 5, further comprising:
placing (i) the plurality of single-column strips and (ii) a third stamp or a third punch face-to-face, wherein the third stamp and the third punch comprise a third base, a plurality of third blades in parallel with each other on the third base, and a plurality of third guides or pegs on the third base and completely outside all space between the outermost ones of the plurality of third blades; and
applying sufficient pressure to at least one of (a) the plurality of single-column strips and (b) the third stamp or the third punch to separate the plurality of single-column strips into the plurality of individual battery cells.

8. The method of claim 7, wherein the third guides or pegs are in locations on the third base identical to locations of the second guides or pegs on the second base, and the plurality of third blades are oriented with respect to the third guides or pegs orthogonally to an orientation of the plurality of second blades with respect to the second guides or pegs.

9. The method of claim 3, wherein each of the second plurality of battery cell strips is a single-column strip, and the method further comprises:
placing (i) the plurality of single-column strips and (ii) a second stamp or a second punch face-to-face, wherein the second stamp and the second punch comprise a second base, a plurality of second blades in parallel with each other on the second base, and a plurality of second guides or pegs on the second base and completely outside all space between the outermost ones of the plurality of second blades; and
applying sufficient pressure to at least one of (a) the plurality of single-column strips and (b) the second stamp or the second punch to singulate the plurality of single-column strips into the plurality of individual battery cells.

10. The method of claim 9, wherein the second guides or pegs are in locations on the second base identical to locations of the first guides or pegs on the first base, and the plurality of second blades are oriented with respect to the second guides or pegs orthogonally to an orientation of the plurality of first blades with respect to the first guides or pegs.

11. The method of claim 1, wherein each of the first plurality of battery cell strips comprises a plurality of columns of battery cells, and the method comprises placing (i) the first plurality of battery cell strips and (ii) the first stamp or the first punch face-to-face, and applying sufficient pressure to either (a) the carrier or (b) the first stamp or the first punch to separate the first plurality of battery cell strips into the second plurality of battery cell strips or the plurality of multi-cell units.

12. The method of claim 11, wherein the first stamp or the first punch separates the first plurality of battery cell strips into a plurality of a single-column strips, and each of the first plurality of battery cell strips includes from two to eight columns of battery cells.

13. The method of claim 11, further comprising:
placing (i) the plurality of single-column strips and (ii) a second stamp or a second punch face-to-face, wherein the second stamp and the second punch comprise a second base, a plurality of second blades in parallel with each other on the second base, and a plurality of second guides or pegs on the second base and completely outside all space between the outermost ones of the plurality of second blades; and
applying sufficient pressure to at least one of (a) the plurality of single-column strips and (b) the second stamp or the second punch to singulate the plurality of single-column strips into the plurality of individual battery cells.

14. A method of assembling a multi-cell solid-state battery, comprising:
the method of claim 1, resulting in the plurality of multi-cell units or the plurality of individual battery cells;
forming a battery cell stack from the plurality of multi-cell units or the plurality of individual battery cells;
placing air and water barriers on uppermost and lowermost surfaces of the battery cell stack;
forming a first battery terminal on an ACC side of the individual battery cells in the battery cell stack; and
forming a second battery terminal on a CCC side of the individual battery cells in the battery cell stack to form the multi-cell solid-state battery.

15. A stamp or punch for cutting or dicing solid-state battery cells, comprising:
a first base,
a plurality of first blades in parallel with each other on the first base,
a plurality of first guides or pegs on the base and completely outside all space between the outermost ones of the plurality of first blades, and
a plurality of blade guides on the base, such that each of the plurality of blades has at least one of the plurality of blade guides at an end of the blade, wherein:
the solid-state battery cells are in an array of rows and columns on a substrate, and form a sheet, a roll or a plurality of first strips,
a space between adjacent ones of the columns or between adjacent ones of the rows defines a dicing channel,
the first plurality of strips are on a carrier,
the plurality of blade guides are configured to align the plurality of blades with each other and/or with at least some of the dicing channels, and
the stamp or punch is configured to separate the sheet, the roll or the first plurality of strips into a second plurality of strips, a plurality of multi-cell units, or a plurality of individual battery cells upon application of sufficient pressure to at least one of (a) the sheet, the roll or the carrier and (b) the stamp or punch.

16. The stamp or punch of claim 15, wherein adjacent ones of the plurality of first blades are spaced apart by n times a width or length of the solid-state battery cell, and n is a positive integer.

17. The stamp or punch of claim 15, wherein each of the plurality of first blades has a first one of the plurality of blade guides at the end of the blade, and a second one of the plurality of blade guides at an opposite end of the blade.

18. The stamp or punch of claim 15, wherein:
the plurality of guides or pegs comprises a first guide or peg, a second guide or peg, a third guide or peg, and a fourth guide or peg,
the first guide or peg is separated along a first direction from the second guide or peg by a first distance,
the first guide or peg is separated along a second direction from the third guide or peg by a second distance,
the first distance differs from the second distance, and
the first direction is orthogonal to the second direction.

19. A set of stamps or punches for cutting or dicing solid-state battery cells, comprising:
the stamp or punch of claim 15, and
a second stamp or punch, comprising:
a second base,
a plurality of second blades in parallel with each other on the second base,
a plurality of second guides or pegs on the base and completely outside all space between the outermost ones of the plurality of second blades, and
a plurality of second blade guides on the second base, such that each of the plurality of second blades has at least one of the plurality of second blade guides at an end of the second blade,
wherein the solid-state battery cells are on a plurality of second strips on a second carrier, and the second stamp or punch is configured to (i) separate the second plurality of strips into a plurality of single-column strips, a second plurality of multi-cell units or the plurality of individual battery cells or (ii) singulate the plurality of multi-cell units into the plurality of individual battery cells upon application of sufficient pressure to at least one of (a) the second carrier and (b) the second stamp or punch.

20. The set of stamps or punches of claim 19, further comprising:
a third stamp or punch, comprising:
a third base,
a plurality of third blades in parallel with each other on the third base,
a plurality of third guides or pegs on the third base and completely outside all space between the outermost ones of the plurality of third blades, and
a plurality of third blade guides on the third base, such that each of the plurality of third blades has at least one of the plurality of third blade guides at an end of the third blade,
wherein the plurality of single-column strips is on a third carrier, and the third stamp or punch is configured to singulate the plurality of single-column strips into the plurality of individual battery cells upon application of sufficient pressure to at least one of (a) the third carrier and (b) the third stamp or punch.
